(19) United States
(12) Patent Application Publication
(10) Pub. No.: US 2026/0033424 A1
(43) Pub. Date: Feb. 5, 2026

(54) AGRICULTURAL COMBINE VEHICLE DISPLAY AUTOMATED CAPTURE METHOD

(71) Applicant: CNH Industrial America LLC, New Holland, PA (US)

(72) Inventors: Robert JONES, Morgantown, PA (US); Michael RUSH, Lancaster, PA (US); Robert GARRETT, Conestoga, PA (US)

(73) Assignee: CNH Industrial America LLC, New Holland, PA (US)

(21) Appl. No.: 18/998,812

(22) PCT Filed: Jul. 28, 2023
(86) PCT No.: PCT/US2023/028916

§ 371 Date: Jan. 27, 2025

Related U.S. Application Data
(60) Provisional application No. 63/393,335, filed on Jul. 29, 2022.

(51) Int. Cl. A01D 41/127; G07C 5/04; G07C 5/06

(52) U.S. Cl. CPC A01D 41/1273; G07C 5/04; G07C 5/06

(57) ABSTRACT

A method of operating an agricultural vehicle includes the steps of: generating active runtime data based on performance of the vehicle, receiving a signal to activate a kill-stall procedure of the vehicle, recording the active runtime data as recorded runtime data prior to kill-stalling the vehicle, and kill-stalling the vehicle.

### FIELD OF THE INVENTION

The present invention relates to agricultural vehicles, and, more particularly, to storage and retrieval methods of performance data depicted in a visual display.

### BACKGROUND OF THE INVENTION

In normal operation, a combine operator tries to optimize the performance of the combine by making various adjustments to operational parameters of the combine and then trying to quantify the positive/negative effect of the change. Various functional components or parameters of a combine can be adjusted by the operator, and their effects on the operating efficiency of the combine can be monitored. For example, the operator can control the forward speed of the combine to change the rate of crop intake. As speed increases, so too does the amount of material collected. However, it is typical that once the combine reaches a certain forward speed, the amount of material lost (i.e., crop ejected from the combine lost without being collected) begins to increase dramatically. This is because the threshing process can only handle a certain volume of material regardless of the forward speed of the combine, and at a certain speed collected grain begins to be lost as the thresher separation process cannot keep up with the amount of material collected.

Additionally, crop losses can be affected by the type of crop being harvested, the conditions of the field or harvesting area, and in particular the settings of the agricultural vehicle. Many agricultural combines allow the operator to tweak the speed and pitch of any number of threshers, belts, and separators. Any of these settings, in concert with both the conditions of the field as well as the passage of time and the amount of crop harvested, can all effect crop losses during harvesting.

Modern combines have formalized the kill-stall maneuver as a built-in kill-stall procedure, thereby removing some of the guess work, error, or long-term negative effects experienced by intentionally stalling the combine by manually choking the engine. The kill-stall procedure can be found as a button, or implemented as a selectable icon in a display in the combine cabin.

To reduce redundancy, the interface display which allows the operator to perform the kill-stall function can be the same display which shows output from a loss monitor, vehicle performance monitors, and vehicle settings. An operator is conventionally able to view this data in real time.

These functions are typically combined into a single display. However, while the operator is performing the kill-stall procedure to optimize or troubleshoot combine settings, the display is showing digital prompts and menus related to the kill-stall procedure, thereby blocking some or all of the output data related to crop losses, vehicle performance, or vehicle settings. These output data would be useful if the operator had access to these values, but as they are obscured the operator must watch the display output and mentally recall the output data before initiating the kill-stall procedure. This recall process must be done nearly concurrently for many different parameters. The recall process is therefore prone to errors and the accuracy is subjective and limited in scope. Additionally, the operator may perform multiple kill-stall procedures throughout a day of harvesting, in order to tweak performance. Having a record of the crop losses, vehicle performance, and vehicle settings as recorded by the combine would be useful for backwards-looking analysis after a harvesting session, to improve future harvesting sessions.

This description of the background is provided to assist with an understanding of the following explanations of exemplary embodiments, and is not an admission that any or all of this background information is necessarily prior art.

### SUMMARY OF THE INVENTION

In one exemplary embodiment, there is provided a method of operating an agricultural vehicle, the method comprises the following steps.

First, generating active runtime data 210A-N based on performance of the agricultural vehicle 100. Second, receiving a signal to activate a kill-stall procedure of the agricultural vehicle 100. Third, prior to kill-stalling the agricultural vehicle 100, recording the active runtime data 210A-N as recorded runtime data 310A-N. Fourth, prior to kill-stalling the agricultural vehicle 100, displaying one or more prompts 387 on display screen 168 requesting the user to confirm kill-stalling the agricultural vehicle 100. It is noted that the recorded runtime data 310A-N does not include the prompts 387. Fifth, kill-stalling the agricultural vehicle 100. Sixth, displaying the recorded runtime data 310A-N (not including prompts 387) to the user via display screen 168 in the form of a screen capture 311.

The recorded runtime data 310A-N can include a timestamp, and the aforementioned active runtime data 210A-N. That active runtime data 210A-N can include settings, crop losses, crop conditions, or a combination thereof. Further, multiple kill-stalls of the agricultural vehicle 100 can result in multiple discrete recordings of the active runtime data 210A-N as recorded runtime data 310A-N.

The method can include transferring the recorded runtime data 310A-N and/or screen capture(s) 311 to an external storage device, such as the USB device disclosed as memory 510. Further, the method can include transferring the recorded runtime data 310A-N to the external storage device 510 via a wireless connection 512. The method can also include the operator adjusting settings of the agricultural vehicle 100 based upon the recorded runtime data 310A-N.

In another exemplary embodiment, there is provided an agricultural vehicle including a processor, a memory coupled to the processor, and programming in the memory. Execution of the programming by the processor configures the agricultural vehicle to perform the following functions. First, to generate active runtime data based on performance of the agricultural vehicle. Second, to receive a signal to activate a kill-stall procedure of the agricultural vehicle. Third, prior to kill-stalling the agricultural vehicle, to record the active runtime data as recorded runtime data. Fourth, to kill-stall the agricultural vehicle.

### BRIEF DESCRIPTION OF THE DRAWINGS

Embodiments of inventions will now be described, strictly by way of example, with reference to the accompanying drawings, in which:

FIG. 1A is a perspective view of an exemplar agricultural combine.

FIG. 1B illustrates various loss sensor locations on the exemplar agricultural combine.

FIG. 2 is an example of an output interface display.

FIG. 3 is an example of the active runtime data obscured by the kill-stall procedure prompts, and the resulting recorded runtime data screen capture taken at the time of stall.

FIG. 4 is a flowchart of the screen capture procedure.

FIG. 5 depicts a block diagram of exemplary hardware and computing equipment that may be used as a control system.

### DETAILED DESCRIPTION OF THE DRAWINGS

The drawing figures depict one or more implementations in accord with the present concepts, by way of example only, not by way of limitations. In the figures, like reference numerals refer to the same or similar elements.

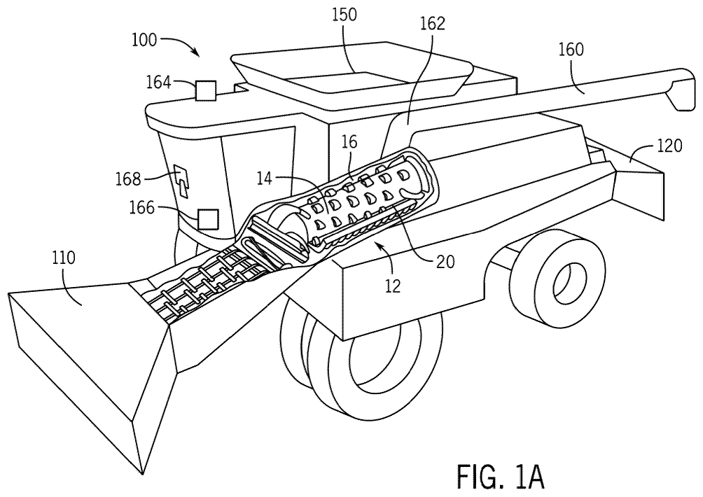

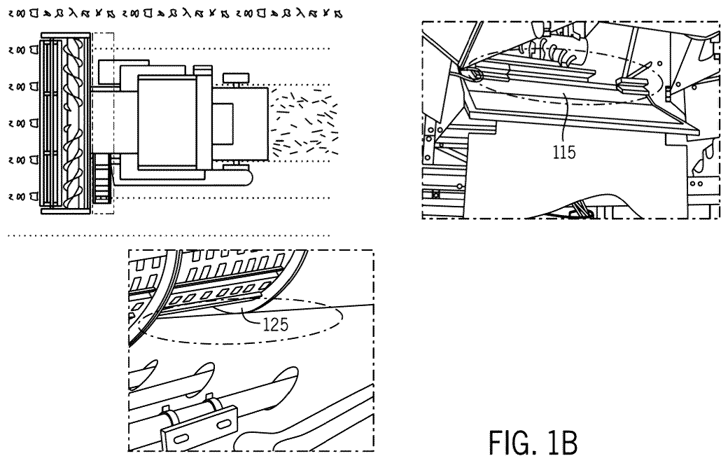

FIG. 1A shows an exemplary agricultural combine 100, which may also be referred as a combine or harvester throughout this specification. As shown in FIG. 1A, the combine 100 can include a header 110 (shown schematically), a longitudinally axially arranged threshing and separating system 12, and a concave 20 within the threshing and separating system 12. The threshing and separating system may also have other known configurations, as known in the art, and embodiments are not limited to an axial threshing system or those having concaves 20. For example, in some embodiments, the concave 20 may be used with a combine having a transversely aligned threshing and separating system, straw walkers, or other devices for threshing the crop.

The exemplary axial threshing and separating system 12 is axially arranged, in that it includes a cylindrical threshing rotor 14 supported and rotatable in a predetermined direction about a rotational axis therethrough for conveying a flow of crop material in a helical flow path through a threshing chamber 16 extending circumferentially around the rotor 14. Concaves 20 may extend circumferentially adjacent the rotor 14 and the flow of crop may pass in the space between the spinning rotor and the concaves 20. As the crop material flows through the threshing and separating system 12, the crop material including, for example, grain, straw, legumes, and the like, is loosened and separated from crop residue or MOG (material other than grain). The separated materials are then carried away from the threshing and separating system 12 in a well-known conventional manner, and crop residue can be redistributed to the field via a spreader 120 (shown schematically), located at the back of the combine 100.

The remaining threshed crop, which includes the grain to be collected, is then cleaned via a cleaning system (not shown). The cleaning system can include conventional winnowing mechanisms including a fan that blows air across a series of reciprocating sieves. The winnowing action of the air and the reciprocating sieves separates the grain from the remaining chaff and collects the clean grain. The clean grain may then be conveyed to a grain tank 150 via conventional devices. One or more cross augers may be provided at the bottom of the grain tank 150 to move grain to an unloading system. In the shown example, the unloading system is a turret-style system having an unload tube 160 and a vertical tube 162.

The combine 100 includes one or more adjustable operating components. For example, the combine 100 may allow adjustment of: ground speed, operating speed of the threshing rotor 14 or other threshing mechanism, position of the concave 20 relative to the rotor 14, positions (spacing, tilt angle, etc.) of separating system sieves or shoes, cleaning fan speed, and so on. Each controllable component may include an associated controller to operate the component. Similarly, each adjustable component may include a feedback or feed-forward sensor to indicate the current setting of the component.

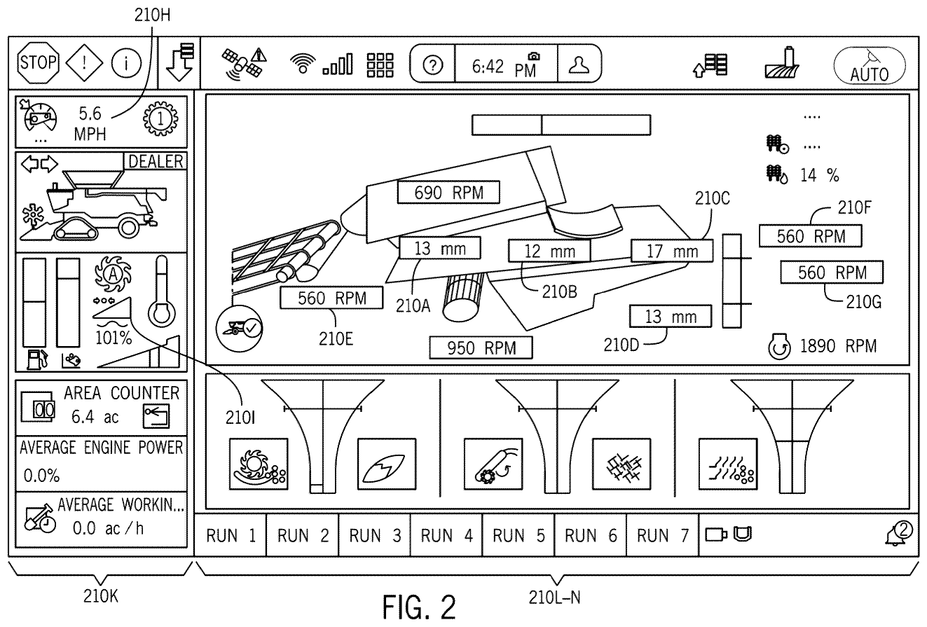

The combine 100 also includes one or more environmental sensors to evaluate status conditions within and around the combine 100. For example, the combine 100 may include a moisture meter to evaluate grain wetness, weight sensors to evaluate grain loading, mass flow rate sensors to evaluate crop processing rate, an odometer to measure distance, ground speed sensors, timers, global positioning, or other navigation sensors 164 to indicate the physical position of the combine, and so on. The combine 100 also includes one or more loss sensors to detect grain that is exiting the combine 100. For example, as shown in FIG. 1B, the combine 100 may include one or more sieve loss sensors 115 at the end of the grain separating sieve, and/or one or more rotor loss sensors 125 at the outlet of the threshing rotor 14 or other threshing mechanism. The grain loss sensors 115 detect grain as it leaves the combine from the separating system, and the rotor loss sensors 125 detect grain as it leaves the combine from the threshing system. Each loss sensor 115, 125 may include one or more piezoelectric sensors that operate by detecting the impingement of grain upon the sensor body, as known in the art, but other sensor devices may be used. There are sensors for reporting each of the data elements shown in the display of FIG. 2.

The combine 100 includes a control system 166 for operating the various adjustable components, and monitoring the operation of the machine. Input may be provided to the control system 166 using various different control devices, such as manually-operable throttles or mechanical adjusters, and electronic input controls. The control system 166 includes a consolidated input interface, such as a computer having input controls (keyboard, mouse, touchscreen display, buttons, etc.) for changing various operating parameters, which may be operable to control all of the combine's operative components or may be operable in conjunction with separate controls for some control inputs (e.g., a manually-operated throttle for controlling ground speed). Any variety of input controls may be used, as known in the art.

The control system 166 also collects data relating to the operation of the combine 100 from the various operating component sensors and environmental sensors, and presents some or all of this data to the combine operator via an output interface 168, such as one or more gauges, screens, displays, or the like. For example, the output interface 168 may comprise a digital display that is operable to graphically indicate any variety of different sensor output information. The output interface 168 also may operate as an input interface for receiving control inputs from the operator. For example, the output interface 168 may comprise a touchscreen display that can be used to observe operating conditions and change operating parameters of the adjustable operating components.

Using the control system 166, the combine operator may change the parameters of the combine and see, on the output interface 168, if that change has affected the operational conditions of the combine. The output interface 168 may be reconfigured to provide various different readouts. For example, FIG. 2 illustrates an output interface 168 display related to the real-time operation of the combine 100. This combine 100 is configured to harvest soybeans. The output interface 168 display in this example shows active runtime data 210A-N, including multiple sieve openings 210A-D, component (e.g. belt) speeds 210E-G; combine forward speed 210H; header height control setting 210I; other generalized combine engine performance 210K including fuel levels, engine power, and oil temperature; and the harvesting performance (e.g. grain loss) 210L-N of various bins within the combine 100 or cutter revolutions per minute (RPM): however, any number of performance factors related to the combine 100, field, crops, or a fleet of combines 100, could be displayed.

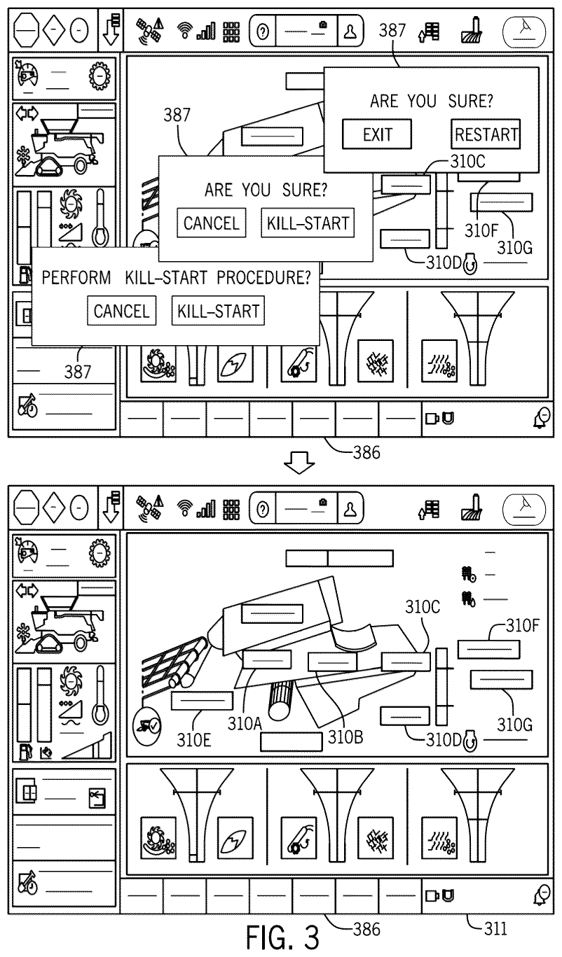

FIG. 3 shows a comparison between the active runtime data 210A-N obscured by the kill-stall procedure prompts 387 (see top screen), and the resulting recorded runtime data 310A-N screen capture (see bottom screen) taken at the time of stall. The bottom screen includes the same underlying recorded runtime data 310A-N as the top screen, however, most of the data on the top screen is obscured by prompts 387.

On the top screen, the output interface 386 shows that the operator has already pressed an icon to activate the kill-stall procedure prompt 387. In the top screen, much of the active runtime data 210A-N is obscured by the three prompts 387. Pressing either “Exit” or “Restart” on the restart combine prompt 387 will result in stalling of the combine, which will result in active runtime data 210A-N resetting (e.g., the speed will be 0.0 MPH, the cutter will be operating at 0% capacity, the belts will move at 0 RPM, etc.). Therefore, the operator is unable to review the active runtime data 210A-N, as it is obscured, and removing the obscuring prompts 387 will clear the active runtime data 210A-N.

However, in this example, as shown in the bottom screen in FIG. 3, after the “Kill-Stall” icon has been selected on the confirmation prompt 387, but before the combine is restarted, a screen capture 311 is captured and saved. Screen capture 311 has the active runtime data 210A-N snapshotted to that instant in time as recorded runtime data 310A-N. Preferably, the kill-stall procedure performs an operating system-level interrupt of the control system 166, and the first operation within that operating system-level interrupt is to save the screen capture 311 (while omitting the prompts 387). The kill-stall procedure is fully scheduled, but none of the steps of prompts 387 have been recorded, indicating that the active runtime data 210A-N when captured as recorded runtime data 310A-N will faithfully represent that active runtime data 210A-N at the time of the kill-stall procedure while the combine is still operating.

Further, in this example, the screen capture 311 is not a conventional screen capture, meaning, the screen capture 311 does not consist of pixel-level data sent from the control system 166 to the output interface 168 display, to be shown by the output interface 168 display without any computational analysis. Generally, the control system 166 performs render cycles, often multiple times per second, and the rendering output of a given render cycle is pixel-level data sent from the control system 166 to the output interface 168 display. As the control system 166 proceeds through a rendering cycle, after all computations and renderings related to the active runtime 210A-N are performed, but before any renderings of prompts 387 are performed, the control system 166 checks whether a kill-stall procedure has been initiated or scheduled. This check is performed by determining whether a kill-stall procedure signal has been sent, or if a kill-stall procedure variable has been set. If a kill-stall procedure has been initiated, and a screen capture has not yet been generated for this particular kill-stall procedure initiation, the current rendered data (consisting of active runtime data 210A-N, and not prompts 387) are sent separately as pixel-level data to a saved computer file, which stores the active runtime data 210A-N as the screen capture 311. The render cycle would then continue to render any prompts 387, and produce the output interface 386 of active runtime data 201A-N obscured by prompts 387 the operator would see in the output interface display 168.

Further, when the decision to store a screen capture 311 occurs, the active runtime data 210A-N may be stored in a conventional computer memory structure, such as a list or dictionary, and be either appended to the screen capture 311 as pixel data, or be stored as binary or ASCII data to be interpreted by a computer at a later time. The screen capture 311 may also not create or store the recorded runtime data 310A-N as visual, pixel-level data, but rather only store the recorded runtime data 310A-N as binary or ASCII formatted-data as a text or data file, in order to save space or improve data processing by a data processing computer. Further, that data file, in combination with programming describing the formatting of the output interface 168 display, may procedurally recreate to an observer the active runtime data 210A-N in the visual format as captured in the screen capture 311 as pixel data, while ultimately only storing the data file. The data file may or may not be human-readable.

As an alternative to that which is described above, the screen capture 311 may be a conventional screen capture consisting of pixel-level data.

Some of the information depicted in screen capture 311 or appended to the data file may include geographical positioning readings of the position of the combine 100 within the field. U.S. Pat. Pub. No. 2020/0245557, which is incorporated by reference herein, described a system in which operating parameter settings and loss data readings of the combine 100 are associated with the position readings of the combine 100.

The loss information in screen capture 311 may be used to provide some measure of combine efficiency. However, this information is often displayed in real-time, and the combine operator may not have time to appreciate or interpret the information during operation of the combine. U.S. Pat. No. 8,930,039, which is incorporated by reference herein, describes a system in which loss data is collected and averaged, to help assist the operator with understanding how harvesting rates affect loss data. The data is presented to the operator graphically in the form of an x-y plot of averaged loss data as a function of combine throughput (e.g., mass flow rate through the combine). Such a feature also may be incorporated into embodiments of the present invention, as it can provide a useful output to the operator.

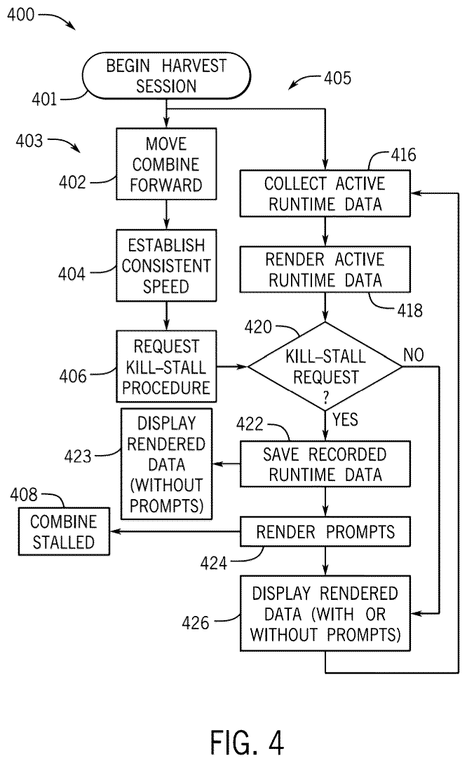

FIG. 4 is a flowchart of the screen capture procedure 400. In block 401, the operator starts the combine 100, thereby starting a harvesting session. A harvesting session can include multiple kill-stall procedures, and can be analogous to a single day's work, however longer and shorter harvesting sessions are considered. Once the combine 100 is started, two independent cycles are initiated. First, an adjustment cycle 403 is initiated, which broadly entails running the combine 100, stopping the combine 100, and adjusting the combine 100. Several adjustment cycles 403 may be performed in a single harvest session. Second, a rendering cycle 405 is initiated, which broadly entails collecting runtime data and displaying that data. If the output interface 168 display is a 30 Hz display, then approximately thirty rendering cycles 405 occur per second.

In block 402 of adjustment cycle 403, the operator moves the combine 100 forward, and begins the harvesting process. Continuing in block 404, the operator may establish a consistent pace or speed for the entirety of the combine 100: cutter, belts, auger—all operating at set speeds and settings after making initial adjustments. After running at a consistent pace, the operator may decide to initiate a kill-stall procedure to assess the performance of the combine 100. In block 406, the operator uses the output interface 168 to send a signal requesting a kill-stall procedure.

Turning now to the rendering cycle 405, that cycle runs concurrently with the adjustment cycle 403. In block 416, the control system 166 continuously collects active runtime data 201A-N. In some examples, not every point of runtime data 210A-N is refreshed every rendering cycle 405. For example, the harvesting performance 210L may only refresh every five seconds, or once a minute. In those examples, the most recent point of runtime data 201A-N is used, unless other logic determines that an error value should be shown instead (e.g., if a value should refresh every second, and has not refreshed in over thirty seconds, an error may be shown rather than the thirty-seconds-stale value.)

Runtime data 210A-N is rendered in block 418. Rendering in this context involves converting digital or analog measurement values into human-readable values, and then further creating instructions for displaying that runtime data 210A-N, including fonts, colors, sizes, proportions, relative or absolute positioning, as well as other user interface elements for an improved reading or interactive experience.

After runtime data 210A-N has been rendered, the screen capture procedure 400 in decision block 420 checks whether the operator has, in block 406, requested a kill-stall procedure. This may be indicated via a signal sent at block 406 to activate the kill-stall procedure, or by checking a variable set by such a signal. If the operator has made a request and sent the signal at block 406, then the answer at decision block 420 is ‘yes’ and the procedure 400 proceeds to block 422. At block 422, the screen capture procedure 400 saves the rendered runtime data 210A-N to a digital file as recorded runtime data 310A-N. At block 423, at a later time (e.g., after the combine has stalled) for example, the recorded runtime data 310A-N is displayed to a user. It should be understood that, at block 423, the recorded runtime data 310A-N is displayed without any prompts 387. This display of recorded runtime data 310A-N is screen capture 311 shown at the bottom of FIG. 3.

After the active runtime data 210A-N has been rendered, and still assuming that the operator requested a kill-stall procedure, the rendering cycle 405 in block 424 renders the prompts 387. This rendering from block 424 is overlaid on the rendering from block 418, thereby obscuring some or all of the active runtime data 210A-N if/when any of the prompts 387 are rendered. Once all of the renderings are completed and overlaid, the renders are sent to the output interface 168 display in block 426, where the rendered runtime data 210A-N and prompts 387 are displayed to the operator as shown at the top of FIG. 3.

If the operator has not sent the signal at block 406, then the answer at decision block 420 is ‘no’ and the procedure 400 proceeds to block 426. At block 426, the renders from block 418 are sent to the output interface 168, where the rendered runtime data 210A-N are displayed to the operator as the output interface shown at the bottom of FIG. 3. It should be understood that there are no prompts in output interface 386 shown at the bottom of FIG. 3 because the kill-stall request procedure has not been requested.

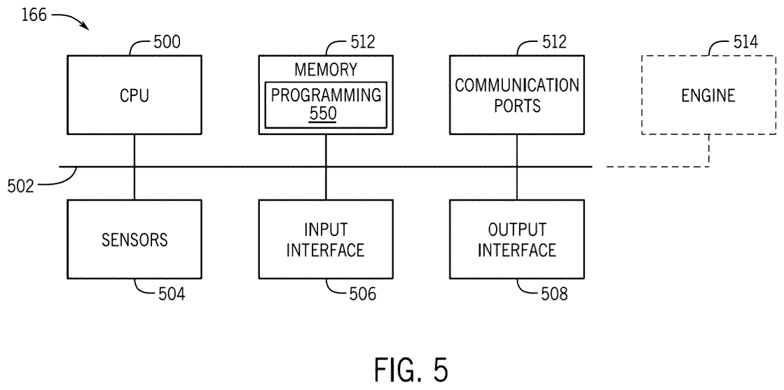

FIG. 5 depicts a block diagram of exemplary hardware and computing equipment the like that may be used as a control system 166 as discussed herein. The control system 166 includes a central processing unit (CPU) 500, which is responsible for performing calculations and logic operations required to execute one or more computer programs or operations. The CPU 500 is connected via a data transmission bus 502, to sensors 504, an input interface 506, an output interface 508, and a memory 510. One or more analog to digital conversion circuits may be provided to convert analog data from the sensors 504 to an appropriate digital signal for processing by the CPU 500, as known in the art. The CPU 500 also may be operatively connected to one or more communication ports 512, such as serial communication ports, wireless communication ports, or the like.

The CPU 500, data transmission bus 502 and memory 510 may comprise any suitable computing device. The selection of an appropriate processing system and memory is a matter of routine practice and need not be discussed in greater detail herein.

The sensors 504 include any number of feedback or feed-forward sensors configured to indicate the desired data, such as digital or analog potentiometer geographical position sensors, optical switches, tachometers, piezoelectric sensors, moisture sensors, accelerometers, temperature sensors, and so on.

The input interface 506 may include any number or type of device used to input instructions or data to the CPU 500, such as a keyboard, pointer (e.g., mouse or smart pen), joystick, touchscreen, buttons, switches, and so on. The output interface 508 may comprise any number of user-perceivable signaling devices, such as a color thin-film transistor (TFT) light emitting diode (LED) backlit display, indicator lights, analog or digital gauges, audio speakers, and so on. The input interface 506 and output interface 508 may be at least partially, or even entirely, integrated into a single unit such as the output interface 168 display, comprising a touchscreen display that is configured to receive input and provide output. The input interface 506 and output interface 508 preferably are located within the cab of the combine 100 where they can be accessed by the combine operator. However, all or portions of the input interface 506 and output interface 508 may be located remotely and communicatively connected to the remaining portions of the control system 166 by wireless communication devices, such as cellular or radio communication transceivers. Such remote configurations may allow remote oversight or even complete operation of the combine 100, as well as remote storage of recorded runtime data 310A-N.

Though not traditionally considered to be part of the control system, the engine 514 of the combine 100 is depicted as connected to the data transmission bus 502: ultimately, the signal to activate the kill-stall procedure and kill-stalling the engine, must reach the engine 514 or a component of the engine 514 capable of stalling the engine 514 and the combine 100.

The control system 166 includes a program application in programming 550 to perform the desired processes. The program application is stored in a tangible computer readable medium in a non-transitory state in the memory 510, and the processor 500 accesses and performs the program application to perform the various processes described herein. The program application may include one or more individual files defining software modules or instructions for performing the functions described herein and various other functions (e.g., engine control and other combine operations), as known in the art. The memory 510 also may store auxiliary data, common files or databases for storing raw and/or processed data, other auxiliary data, as well as recorded runtime data 310A-N.

It is to be understood that the operational steps are performed by the control system 166 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the control system 166 described herein is implemented in software code or instructions which are tangibly stored on a tangible computer readable medium. Upon loading and executing such software code or instructions by the control system 166, the control system 166 may perform any of the functionality of the control system 166 described herein, including any steps of the methods described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The present disclosure describes a number of inventive features and/or combinations of features that may be used alone or in combination with each other or in combination with other technologies. The embodiments described herein are all exemplary, and are not intended to limit the scope of the claims. It will also be appreciated that the inventions described herein can be modified and adapted in various ways, and all such modifications and adaptations are intended to be included in the scope of this disclosure and the appended claims.

What is claimed is:

1. A method of operating an agricultural vehicle, the method comprising the steps of:
generating active runtime data based on performance of the agricultural vehicle;
receiving a signal to activate a kill-stall procedure of the agricultural vehicle;
prior to kill-stalling the agricultural vehicle, recording the active runtime data as recorded runtime data; and
kill-stalling the agricultural vehicle.

2. The method of claim 1, wherein:
the step of generating active runtime data further comprises displaying the active runtime data on a display screen of the agricultural vehicle.

3. The method of claim 1, wherein:
the kill-stall results in a stall of an engine of the agricultural vehicle.

4. The method of claim 3, wherein:
the stall of the engine is caused by an operator engaging the kill-stall procedure of the agricultural vehicle.

5. The method of claim 1, further comprising displaying the active runtime data, and displaying interface prompts on the screen that request confirmation of the kill-stall procedure, wherein the interface prompts obscure the active runtime data.

6. The method of claim 5, wherein:
the recorded runtime data is presented to an operator via a display screen, and the recorded runtime data is a digital file comprising a screen capture of the display screen existing prior to kill-stalling the vehicle.

7. The method of claim 6, wherein:
the screen capture of the display screen depicts the active runtime data presented to the operator via the display screen unobscured by the interface prompts.

8. The method of claim 5, wherein:
the recorded runtime data is presented to the operator via the display screen.

9. The method of claim 1, wherein:
the recorded runtime data includes a timestamp.

10. The method of claim 1, wherein:
the active runtime data includes:
i) settings,
ii) crop losses,
iii) crop conditions, or
iv) a combination thereof.

11. The method of claim 1, wherein multiple kill-stalls of the agricultural vehicle result in multiple discrete recordings of the active runtime data as recorded runtime data.

12. The method of claim 1, further comprising:
transferring the recorded runtime data to an external storage device.

13. The method of claim 1, further comprising:
adjusting settings of the agricultural vehicle based upon the recorded runtime data.

14. An agricultural vehicle, comprising:
a processor;
a memory coupled to the processor; and
programming in the memory, wherein execution of the programming by the processor configures the agricultural vehicle to perform functions, including functions to:
generate active runtime data based on performance of the agricultural vehicle;
receive a signal to activate a kill-stall procedure of the agricultural vehicle;
prior to kill-stalling the agricultural vehicle, record the active runtime data as recorded runtime data; and
kill-stall the agricultural vehicle.

15. The agricultural vehicle of claim 14, further comprising an engine, wherein the kill-stall results in a stall of an engine of the agricultural vehicle.

16. The agricultural vehicle of claim 15, further comprising an interface, wherein the interface presents a kill-stall procedure configured to stall the engine.

17. The agricultural vehicle of claim 16, wherein the interface includes a display screen, and the active runtime data is presented via the display screen.
